(19) United States
(12) Patent Application Publication
(10) Pub. No.: US 2016/0286119 A1
(43) Pub. Date: Sep. 29, 2016

(54) Mobile Device-Mountable Panoramic Camera System and Method of Displaying Images Captured Therefrom

(71) Applicant: 360fly, Inc., Fort Lauderdale, FL (US)

(72) Inventor: Michael Rondinelli, Canonsburg, PA (US)

(21) Appl. No.: 15/171,933

(22) Filed: Jun. 2, 2016

Related U.S. Application Data
(63) Continuation-in-part of application No. 13/448,673, filed on Apr. 17, 2012.
(60) Provisional application No. 62/169,656, filed on Jun. 2, 2015.
(60) Provisional application No. 61/476,634, filed on Apr. 18, 2011.

(51) Int. Cl. H04N 5/232; G02B 13/06; H04N 5/225

(52) U.S. Cl. CPC H04N 5/23216; H04N 5/2254; H04N 5/23238; H04N 5/23293; G02B 13/06

(57) ABSTRACT

A mobile device-mountable camera apparatus includes a panoramic camera system and a cable-free mounting arrangement. The panoramic camera system includes a panoramic lens assembly and a sensor. The lens assembly provides a vertical field of view in a range of greater than 180° to 360°. The sensor is positioned in image-receiving relation to the lens assembly and is operable to produce image data based on an image received through the lens assembly. The mounting arrangement is configured to removably secure the panoramic camera system to an externally-accessible data port of a mobile computing device to facilitate transfer of the image data to processing circuitry of the mobile device. The mobile device's processing circuitry may produce a video image from the image data and display of the video image may be manipulated based on a change of orientation of the mobile device and/or a touch action of the device user.

### CROSS-REFERENCE TO RELATED APPLICATIONS

The present application is a continuation-in-part of U.S. application Ser. No. 13/448,673 filed on Apr. 17, 2012 and claims the benefit of U.S. Provisional Application Ser. No. 62/169,656 filed Jun. 2, 2015, which applications are incorporated herein by reference as if fully set forth herein. Application Ser. No. 13/448,673 claims the benefit of U.S. Provisional Application Ser. No. 61/476,634, filed Apr. 18, 2011, which application is also hereby incorporated by reference as if fully set forth herein.

### TECHNICAL FIELD

The present disclosure relates generally to panoramic imaging and, more particularly, to mounting a panoramic camera system to a mobile computing device and optionally using sensors, processing functionality, and user interface functionality of the mobile computing device to display images captured by the panoramic camera system.

### BACKGROUND

Panoramic imagery is able to capture a large azimuth view with a significant elevation angle. In some cases, the view is achieved through the use of wide angle optics such as a fish-eye lens. This view may be expanded by combining or “stitching” a series of images from one or more cameras with overlapping fields of view into one continuous view. In other cases, it is achieved through the use of a system of mirrors and/or lenses. Alternatively, the view may be developed by rotating an imaging sensor so as to achieve a panorama. The panoramic view can be composed of still images or, in cases where the images are taken at high frequencies, the sequence can be interpreted as animation. Wide angles associated with panoramic imagery can cause the image to appear warped (i.e., the image does not correspond to a natural human view). This imagery can be unwarped by various means, including software, to display a natural view.

While camera systems exist for recording and transmitting panoramic images, such systems typically require images to be uploaded to a web or application server and/or be viewed and edited by a separate device, such as a computer or a smart phone. As a result, such camera systems require network connectivity and the hardware and software capabilities to support it, which add significant cost and complexity to the camera system.

### SUMMARY

The present invention provides panoramic camera systems including a panoramic lens assembly and a sensor for capturing panoramic images. An encoder may also be part of the camera system. The panoramic camera system may be removably mounted on a smart phone or similar device through the use of the charging/data port of the device. The mounting arrangement may provide both structural support for the camera system and a data connection for downloading panoramic image data to the smart phone. An app or other suitable software may be provided to store, manipulate, display and/or transmit the images using the smart phone. Although the term “smart” phone is primarily used herein to describe the device to which the panoramic camera system may be mounted, it is to be understood that any suitable mobile computing and/or display device may be used in accordance with the present invention.

### BRIEF DESCRIPTION OF THE DRAWINGS

FIG. 1 is an isometric view of a camera system including a panoramic lens assembly and sensor mounted on a mobile computing device, in accordance with one exemplary embodiment of the present invention.

FIG. 2 is a perspective front view of the mobile computing device-mounted panoramic camera system of FIG. 1.

FIG. 3 is a front view of the mobile computing device-mounted panoramic camera system of FIG. 1.

FIG. 4 is a side view of the mobile computing device-mounted panoramic camera system of FIG. 1.

FIG. 5 is an exploded view of a panoramic camera system including a panoramic lens assembly and a base including an image sensor, in accordance with an exemplary embodiment of the present invention.

FIG. 6 illustrates a panoramic hyper-fisheye lens with a field of view for use in a mobile device-mountable panoramic camera system, in accordance with one exemplary embodiment of the present invention.

FIG. 7 is a partially schematic front view of a panoramic camera system mounted on a mobile computing device by a mounting element, in accordance with an exemplary embodiment of the present invention.

FIG. 8 is a partially schematic side view of the panoramic camera system mounted on a mobile computing device as shown in FIG. 7.

FIG. 9 is a partially schematic side view of a panoramic camera system mounted on a mobile computing device by a mounting element and movable brackets, in accordance with another exemplary embodiment of the present invention.

FIG. 10 is a partially schematic front view of a panoramic camera system mounted on a mobile computing device by a mounting element and alternative movable brackets, in accordance with a further exemplary embodiment of the present invention.

FIG. 11 is a partially schematic side view illustrating use of a mounting adapter to mount a panoramic camera system to a mobile computing device, in accordance with another exemplary embodiment of the present invention.

FIG. 12 is is a partially schematic side view illustrating use of a rotatable adapter to mount a panoramic camera system to a mobile computing device, in accordance with yet another exemplary embodiment of the present invention.

FIG. 13 illustrates use of touchscreen user commands to perform pan and tilt functions for images captured with a panoramic camera system mounted to a mobile computing device, in accordance with a further exemplary embodiment of the present invention.

FIGS. 14A and 14B illustrate use of touchscreen user commands to perform zoom in and zoom out functions for images captured with a panoramic camera system mounted to a mobile computing device, in accordance with another exemplary embodiment of the present invention.

FIG. 15 illustrates using movement of a mobile computing device to perform pan functions for images captured with a panoramic camera system mounted to the mobile computing device, in accordance with a further exemplary embodiment of the present invention.

FIG. 16 illustrates using movement of a mobile computing device to perform tilt functions for images captured with a panoramic camera system mounted to the mobile computing device, in accordance with another exemplary embodiment of the present invention.

FIG. 17 illustrates using movement of a mobile computing device to perform roll correction functions for images captured with a panoramic camera system mounted to the mobile computing device, in accordance with a further exemplary embodiment of the present invention.

Those skilled in the field of the present disclosure will appreciate that elements in the drawings are illustrated for simplicity and clarity and have not necessarily been drawn to scale. For example, the dimensions of some of the elements in the drawings may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. The details of well-known elements, structure, or processes that would be necessary to practice the embodiments, and that would be well known to those of skill in the art, are not necessarily shown and should be assumed to be present unless otherwise indicated.

### DETAILED DESCRIPTION

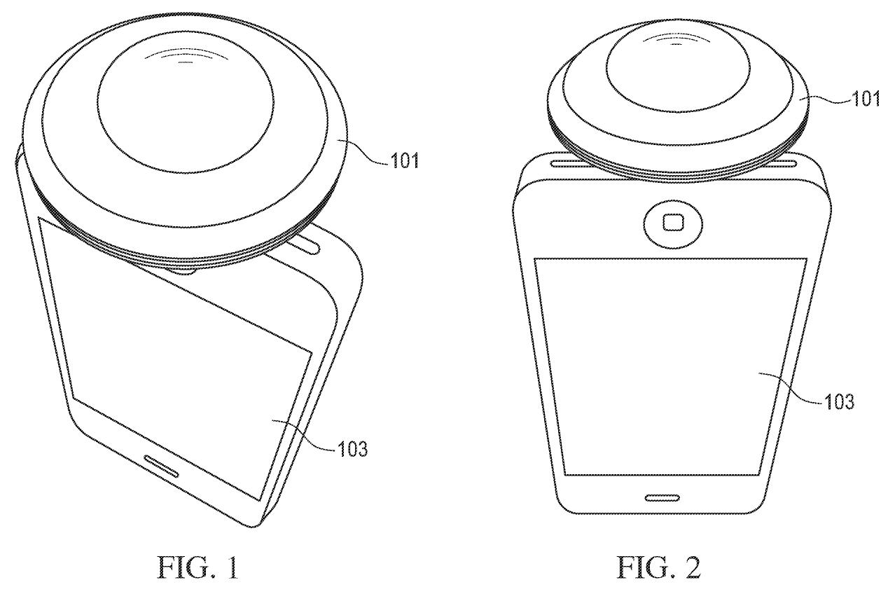

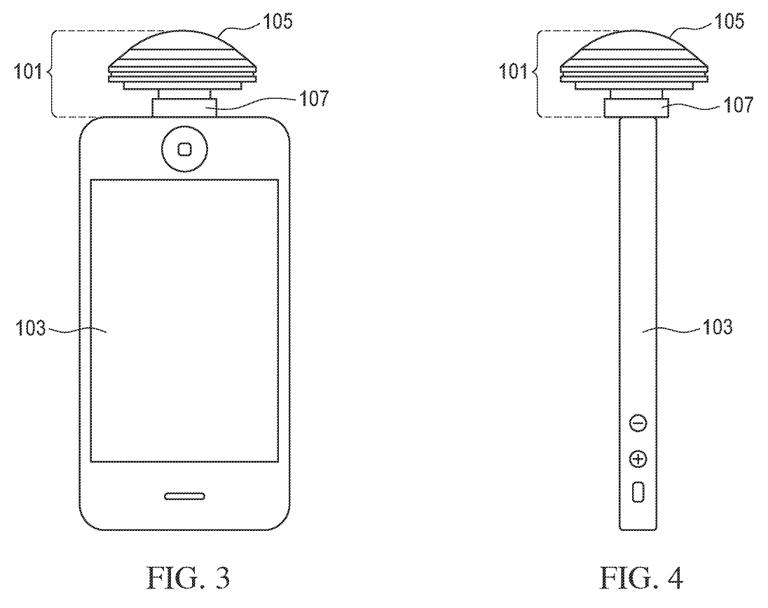

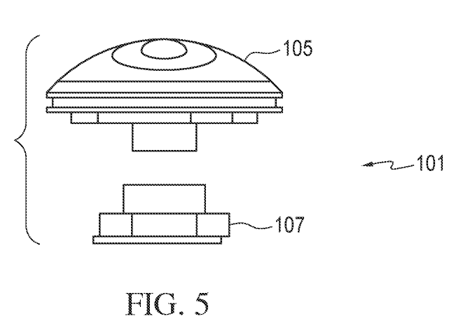

Exemplary aspects and features of the present invention may be more readily understood with reference to FIGS. 1-17, in which like reference numerals refer to identical or functionally similar elements throughout the separate views. For example, FIGS. 1-6 illustrate an exemplary panoramic camera system 101 mounted to a mobile computing device 103, such as a smart phone or other hand-carryable computing device with sufficient processing capability to perform some or all of the below-described functions. In certain embodiments, the panoramic camera system 101 is capable of capturing a 360° field of view around a principal axis, which is often oriented to provide a 360° horizontal field of view. The camera system 101 may also be capable of capturing at least a 180° field of view around a secondary axis, e.g., a vertical field of view. For example, the secondary field of view may be greater than 180° up to 360°, e.g., from 200° to 300°, or from 220° to 270°. Examples of panoramic mirrored systems that may be used are disclosed in U.S. Pat. Nos. 6,856,472; 7,058,239; and 7,123,777, which are incorporated herein by reference.

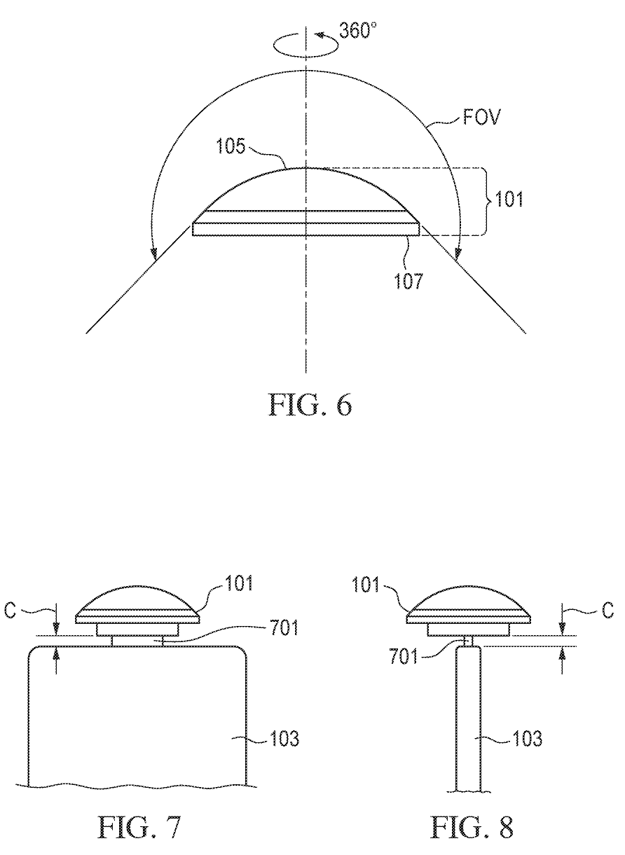

In certain embodiments, the panoramic video camera system 101 may include a panoramic hyper-fisheye lens assembly 105 with a sufficiently large field of view to enable panoramic imaging. FIG. 6 illustrates a panoramic hyper-fisheye lens assembly 105 with a field of view (FOV). The FOV may be from greater than 180° up to 360°, e.g., from 200° to 300°, or from 220° to 270°. In addition to the FOV, FIG. 6 also illustrates a vertical axis around which a 360° horizontal field of view is rotated. However, for a hyper-fisheye lens 105 as shown in FIG. 6, the nomenclature “FOV” (e.g., of from 180° to 360) is typically used to describe the vertical field of view of such lenses. In alternative embodiments, two or more panoramic hyper-fisheye lenses may be mounted on the mobile device, e.g., on opposite sides of the device.

The panoramic imaging system 101 may comprise one or more transmissive hyper-fisheye lenses with multiple transmissive lens elements (e.g., dioptric systems); reflective mirror systems (e.g., panoramic mirrors as disclosed in the U.S. patents cited above); or catadioptric systems comprising combinations of transmissive lens(es) and mirror(s).

In the embodiments shown in FIGS. 1-12, the panoramic imaging system 101 includes a panoramic lens assembly 105 and a sensor 107. The panoramic lens assembly 105 may comprise a dioptric hyper-fisheye lens that provides a relatively low height profile (e.g., the height of the hyper-fisheye lens assembly 105 may be less than or equal to its width or diameter). In certain embodiments, the weight of the hyper-fisheye lens assembly 105 is less than 100 grams, for example, less than 80 grams, or less than 60 grams, or less than 50 grams.

The sensor 107 may comprise any suitable type of conventional sensor, such as CMOS or CCD imagers, or the like. In certain embodiments, raw sensor data is sent from the sensor 107 to the mobile computing device 103 “as is” (e.g., the raw panoramic image data captured by the sensor 107 is sent through the charging/data port in an un-warped and non-compressed form).

In alternative embodiments, the panoramic camera system 101 may also include an encoder (not separately shown in the drawings, but could be included with the sensor 107). In such a case, the raw sensor data from the sensor 107 may be compressed by the encoder prior to transmission to the mobile computing device 103 (e.g., using conventional encoders, such as JPEG, H.264, H.265, and the like). In further alternative embodiments, video data from certain regions of the sensor 503 may be eliminated prior to transmission of the data to the mobile computing device 103 (e.g., the “corners” of a sensor having a square surface area may be eliminated because they do not include useful image data from the circular image produced by the panoramic lens assembly 105, and/or image data from a side portion of a rectangular sensor may be eliminated in a region where the circular panoramic image is not present).

The panoramic camera system 101 may be powered through the charging/data port of the mobile computing device 103. Alternatively, the panoramic camera system 101 may be powered by an on-board battery or other power storage device.

In accordance with further embodiments of the present disclosure, the panoramic camera system 101 may be removably mounted on or to various types of mobile computing devices using the charging/data ports of such devices. The mounting arrangement provides secure mechanical attachment between the panoramic camera system and the mobile computing device 103, while utilizing the data transfer capabilities of the mobile device's data port. Some examples of mounting mechanisms or arrangements are schematically illustrated in FIGS. 7-12.

FIG. 7 is a front view and FIG. 8 is a side view of a panoramic camera system 101 mounted on a mobile computing device 103 by a mounting element 701. In some exemplary embodiments, the mounting element 107 is designed to be held in the charging/data port of the mobile computing device 103. It will be recognized that different types of mobile computing device have different charging/data port configurations, and the mounting element 701 may be configured to be received and held within such various types of charging/data ports. A different mounting element size and shape may be provided for each different type of charging/data port of various mobile computing devices 103. Alternatively, an adjustable mounting element may be provided for various charging/data ports, or adaptors may be provided for receiving a standard mounting element while having different male connectors for various different charging/data ports.

In other exemplary embodiments, the mounting element 701 may be configured to provide a frictional or other type of fit within the charging/data port such that a specified amount of force is required to insert and remove the panoramic camera system 101 from the charging/data port of the mobile computing device 103 (e.g., a removal force of from 5 to 20 pounds, such as a removal force of about 10 pounds). Alternatively, any suitable type of mechanical, elastic, spring-loaded, or other form-fitting device may be used to secure the mounting element 107 within the charging/data port of the mobile computing device 103.

As shown in FIGS. 7 and 8, a clearance space C may be provided between the base of the panoramic camera system 101 and the body of the mobile computing device 103. Such a clearance C allows for the use of various types of protective and/or aesthetic mobile device cases (not shown). For example, the clearance C may be sized to allow the use of mobile device cases having thicknesses that are less than or equal to the clearance spacing C.

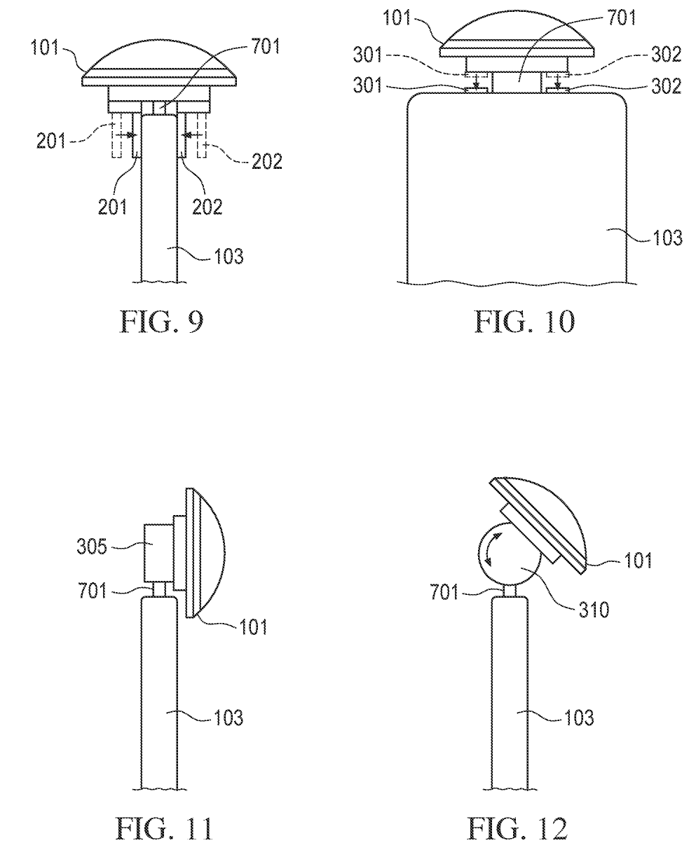

FIG. 9 is a partially schematic side view of a mobile computing device 103 and a panoramic camera system 101 mounted thereon through the use of movable brackets 201, 202 that may engage with the front and back faces of the mobile computing device 103, or the front and back portions of any case (not shown) that may be used to cover the mobile computing device 103. The brackets 201, 202 may be moved from disengaged positions, shown in phantom in FIG. 9, to engaged positions, shown with solid lines. In their engaged positions, the brackets 201, 202 may provide additional mechanical support for the panoramic camera system 101 (e.g., the brackets 201, 202 may supplement the mechanical force provided by the mounting element 701). Any suitable mechanism or arrangement may be used to move the brackets 201, 202 from their disengaged to engaged positions (e.g., spring-loaded mountings, flexible mountings, etc.).

FIG. 10 schematically illustrates an alternative mounting bracket arrangement for mounting the panoramic camera system 101 to a mobile computing device 103. In this embodiment, one or more mounting brackets 301, 302 may be moved from disengaged positions, shown in phantom in FIG. 10, to engaged positions, shown with solid lines. The brackets 301, 302 may be spring loaded to press against the upper surface of the mobile computing device 103, or any case that is used in association with the mobile computing device 103. Such an arrangement may provide mechanical support in addition to the mechanical support provided by the mounting element 701.

FIG. 11 is a partially schematic side view illustrating another alternative mounting adapter 305 used to mount the panoramic camera system 101 to a mobile computing device 103. The adapter 305 is connected between the mounting element 701 and a base of the panoramic camera system 101. The adapter 305 may thus be used to alter the orientation of the panoramic camera system 101 with respect to the orientation of the mobile computing device 103. Although the adapter 305 shown in FIG. 11 is used to mount the panoramic camera system 101 at a fixed 90° offset with respect to the camera system orientations shown in the embodiments of FIGS. 7-10, any other desired orientation may be selected.

FIG. 12 is a partially schematic side view of an alternative rotatable mounting adapter 310 used to mount the panoramic camera system 101 to a mobile computing device 103. The rotatable adapter 310 is connected to the mounting element 701 and a base of the panoramic camera system 101, and provides selectably rotatable movement of the panoramic camera system 101 relative to the mobile computing device 103.

In accordance with further alternative embodiments of the present disclosure, the relative orientations of the panoramic camera system 101 and the mobile computing device 103, such as those shown in FIGS. 7-12, may be detected or otherwise determined. For example, according to one embodiment, an inertial measurement unit (IMU), accelerometer, gyroscope or the like may be provided in the mobile computing device 103 and/or may be mounted on or in the panoramic camera system 101 in order to detect an orientation of the mobile computing device 103 and/or the orientation of the panoramic camera system 101 during operation of the video camera system 101.

At least one microphone (not shown) may optionally be provided on the camera system 101 to detect sound. Alternatively, at least one microphone may be provided as part of the mobile computing device 103. One or more microphones may be used, and may be mounted on the panoramic camera system 101 and/or the mobile computing device 103 and/or be positioned remotely from the camera system 101 and device 103. In the event that multiple channels of audio data are recorded from a plurality of microphones in a known orientation, the audio field may be rotated during playback to synchronize spatially with the interactive renderer display. The microphone output may be stored in an audio buffer and compressed before being recorded. A speaker (not shown) may provide sound output (e.g., from an audio buffer, synchronized to video being displayed from the interactive render) using an integrated speaker device and/or an externally connected speaker device. In the event that multiple channels of audio data are recorded from a plurality of microphones in a known orientation, the audio field may be rotated during playback to synchronize spatially with the interactive renderer display.

The panoramic camera system 101 and/or the mobile computing device 103 may include one or more motion sensors (not shown), such as a global positioning system (GPS) sensor, an accelerometer, a gyroscope, and/or a compass that produce data simultaneously with the optical and, optionally, audio data. Such motion sensors can be used to provide orientation, position, and/or motion information used to perform some of the image processing and display functions described herein. This data may be encoded and recorded.

The panoramic camera system 101 and/or a mobile device processor can retrieve position information from GPS data. Absolute yaw orientation can be retrieved from compass data, acceleration due to gravity may be determined through a 3-axis accelerometer when the mobile computing device 103 is at rest, and changes in pitch, roll and yaw can be determined from gyroscope data. Velocity can be determined from GPS coordinates and timestamps from the mobile device software platform's clock; finer precision values can be achieved by incorporating the results of integrating acceleration data over time.

An interactive renderer of the mobile computing device 103 (e.g., a touch screen display) may combine user input (touch actions), still or motion image data from the camera system 101 (e.g., via a texture map), and movement data (e.g., encoded from geospatial/orientation data) to provide a user controlled view of prerecorded media, shared media downloaded or streamed over a network, or media currently being recorded or previewed. User input can be used in real time to determine the view orientation and zoom. As used in this description, “real time” means that a display shows images at essentially the same time as the images are being captured by an imaging device, such as the panoramic camera system 101, or at a delay that is not obvious to a human user of the imaging device, and/or the display shows image changes in response to user input at essentially the same time as the user input is received. By combining a panoramic camera system 101 with a mobile computing device 103 capable of processing video/image data, the internal signal processing bandwidth can be sufficient to achieve real time display.

Video, audio, and/or geospatial/orientation/motion data can be stored to either the mobile computing device's local storage medium, an externally connected storage medium, or another computing device over a network.

For mobile computing devices that make gyroscope data available, such data indicates changes in rotation along multiple axes over time and can be integrated over a time interval between a previous rendered frame and a current, to-be-rendered frame. This total change in orientation can be added to the orientation used to render the previous frame to determine the new orientation used to render the current frame. In cases where both gyroscope and compass data are available, gyroscope data can be synchronized to compass positions periodically or as a one-time initial offset.

Orientation-based tilt can be derived from accelerometer data, allowing the user to change the displaying tilt range by physically tilting the mobile computing device 103. This can be accomplished by computing the live gravity vector relative to the mobile device 103. The angle of the gravity vector in relation to the mobile device 103 along the device's display plane will match the tilt angle of the mobile device 103. This tilt data can be mapped against tilt data in the recorded media. In cases where recorded tilt data is not available, an arbitrary horizon value can be mapped onto the recorded media. The tilt of the mobile device 103 may be used to either directly specify the tilt angle for rendering (i.e. holding the mobile device 103 vertically may center the view on the horizon), or it may be used with an arbitrary offset for the convenience of the operator. This offset may be determined based on the initial orientation of the mobile device 103 when playback begins (e.g. the angular position of the mobile device 103 when playback is started can be centered on the horizon).

For mobile computing devices 103 that make gyroscope data available, such data indicates changes in rotation along multiple axes over time, and can be integrated over a time interval between a previous rendered frame and a current, to-be-rendered frame. This total change in orientation can be added to the orientation used to render the previous frame to determine the new orientation used to render the current frame. In cases where both gyroscope and accelerometer data are available, gyroscope data can be synchronized to the gravity vector periodically or as a one-time initial offset. Automatic roll correction can be computed as the angle between the mobile device's vertical display axis and the gravity vector from the mobile device's accelerometer.

Various signal processing and image manipulation features may be provided by the mobile device's processor. The panoramic camera system 101 outputs image pixel data to a frame buffer in memory of the mobile device 103. Then, the images are texture mapped by the processor of the mobile device 103. The texture mapped images are unwarped and compressed by the mobile device processor before being recorded in mobile device memory.

A touch screen is provided by the mobile device 103 to sense touch actions provided by a user. User touch actions and sensor data may be used to select a particular viewing direction, which is then rendered on a display by the mobile device processor. The mobile computing device 103 can interactively render texture mapped video data in combination with user touch actions and/or sensor data to produce video for a display. The signal processing can be performed by a processor or processing circuitry in the mobile computing device 103. The processing circuitry can include a processor programmed using software that implements the functions described herein.

Many mobile computing devices, such as the iPhone, contain built-in touch screen or touch screen input sensors that can be used to receive user commands. In usage scenarios where a software platform does not contain a built-in touch or touch screen sensor, externally connected input devices can be used. User input such as touching, dragging, and pinching can be detected as touch actions by touch and touch screen sensors though the usage of off-the-shelf software frameworks.

User input, in the form of touch actions, can be provided to a software application by hardware abstraction frameworks on the software platform. These touch actions enable the software application to provide the user with an interactive presentation of prerecorded media, shared media downloaded or streamed from the internet, or media which is currently being recorded or previewed.

The video frame buffer is a hardware abstraction that can be provided by an off-the-shelf software framework, storing one or more frames of the most recently captured still or motion image. These frames can be retrieved by the software application for various uses.

The texture map is a single frame retrieved by the software application from the video buffer. This frame may be refreshed periodically from the video frame buffer in order to display a sequence of video.

The mobile device processor can retrieve position information from GPS data. Absolute yaw orientation can be retrieved from compass data, acceleration due to gravity may be determined through a 3-axis accelerometer when the mobile computing device 103 is at rest, and changes in pitch, roll and yaw can be determined from gyroscope data. Velocity can be determined from GPS coordinates and timestamps from the mobile device software platform's clock; finer precision values can be achieved by incorporating the results of integrating acceleration data over time.

The interactive renderer of the mobile computing device 103 combines user input (touch actions), still or motion image data from the panoramic camera system 101 (e.g., via a texture map), and movement data (e.g., encoded from geospatial/orientation data) to provide a user controlled view of prerecorded media, shared media downloaded or streamed over a network, or media currently being recorded or previewed. User input can be used in real time to determine the view orientation and zoom. By coupling a panoramic optic, such as the panoramic camera system 101, to a mobile computing device 103 capable of processing video/image data, the internal signal processing bandwidth can be sufficient to achieve real time display.

A texture map supplied by the panoramic camera system 101 can be applied to a spherical, cylindrical, cubic, or other geometric mesh of vertices, providing a virtual scene for the view, correlating known angle coordinates from the texture map with desired angle coordinates of each vertex. In addition, the view can be adjusted using orientation data to account for changes in pitch, yaw, and roll of the mobile computing device 103.

An unwarped version of each video frame can be produced by the mobile device processor by mapping still or motion image textures onto a flat mesh correlating desired angle coordinates of each vertex with known angle coordinates from the texture map.

Many software platforms provide a facility for encoding sequences of video frames using a video compression algorithm. One common algorithm is MPEG-4 Part 10, Advanced Video Coding (AVC) or H.264 compression. The video compression algorithm may be implemented as a hardware feature of the mobile computing device 103, through software which runs on the general central processing unit (CPU) of the mobile device 103, or as a combination thereof. Frames of unwarped video can be passed to such a compression algorithm to produce a compressed video data stream. This compressed video data stream can be suitable for recording on the mobile device's internal persistent memory, and/or for being transmitted through a wired or wireless network to a server or another mobile computing device.

Many software platforms also provide a facility for encoding sequences of audio data using an audio compression algorithm. One common audio compression algorithm is Advanced Audio coding (AAC) compression. The audio compression algorithm may be implemented as a hardware feature of the mobile computing device 103, through software which runs on the general CPU of the mobile device 103, or as a combination thereof. Frames of audio data can be passed to such a compression algorithm to produce a compressed audio data stream. The compressed audio data stream can be suitable for recording on the mobile computing device's internal persistent memory, or for being transmitted through a wired or wireless network to a server or another mobile computing device. The compressed audio data stream may be interlaced with a compressed video stream to produce a synchronized movie file.

Display views from the mobile device's interactive render can be produced using either an integrated display device, such as the display screen on the mobile device 103, or an externally connected display device. Further, if multiple display devices are connected, each display device may feature its own distinct view of the scene.

Video, audio, and geospatial/orientation/motion data can be stored to the mobile computing device's local storage medium, an externally connected storage medium, and/or another computing device over a network.

Images processed from the panoramic camera system 101 or other sources may be displayed in any suitable manner. For example, a touch screen may be provided in or on the mobile computing device 103 to sense touch actions provided by a user. User touch actions and sensor data may be used to select a particular viewing direction of a displayed image, which is then rendered. The mobile device 103 can interactively render the texture mapped video data in combination with the user touch actions and/or the sensor data to produce video for display. The signal processing can be performed by a processor or processing circuitry of the mobile device 103.

Video images processed by the mobile device 103 may be downloaded to various display devices, such as the mobile device's display, using an application (app). Many mobile computing devices, such as the iPhone, contain built-in touch screen or touch screen input sensors that can be used to receive user commands. In usage scenarios where a software platform does not contain a built-in touch or touch screen sensor, externally connected input devices can be used. User input, such as touching, dragging, and pinching, can be detected as touch actions by touch and touch screen sensors though the usage of off-the-shelf software frameworks.

User input, in the form of touch actions, can be provided to the mobile device software application by hardware abstraction frameworks on the software platform. These touch actions enable the software application to provide the user with an interactive presentation of prerecorded media, shared media downloaded or streamed from the internet, or media which is currently being recorded or previewed.

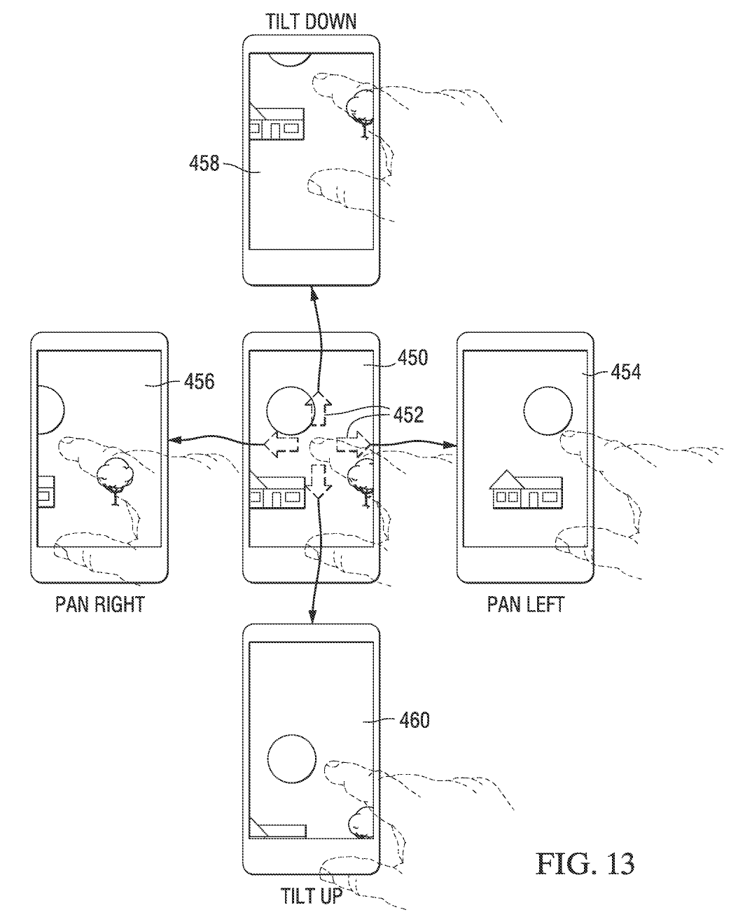

FIG. 13 illustrates pan and tilt software-implemented display functions in response to user commands. The mobile computing device 103 is shown with the camera system 101 removed in FIGS. 13-17. For purposes of discussing FIGS. 13-17, the mobile computing device 103 includes a touch screen display 450. A user can touch the screen and move in the directions shown by arrows 452 to change the displayed image to achieve pan and/or tilt function. In screen 454, the image is changed as if the camera field of view is panned to the left. In screen 456, the image is changed as if the camera field of view is panned to the right. In screen 458, the image is changed as if the camera is tilted down. In screen 460, the image is changed as if the camera is tilted up. As shown in FIG. 13, touch based pan and tilt allows the user to change the viewing region by following single contact drag. The initial point of contact from the user's touch is mapped to a pan/tilt coordinate, and pan/tilt adjustments are computed during dragging to keep that pan/tilt coordinate under the user's finger.

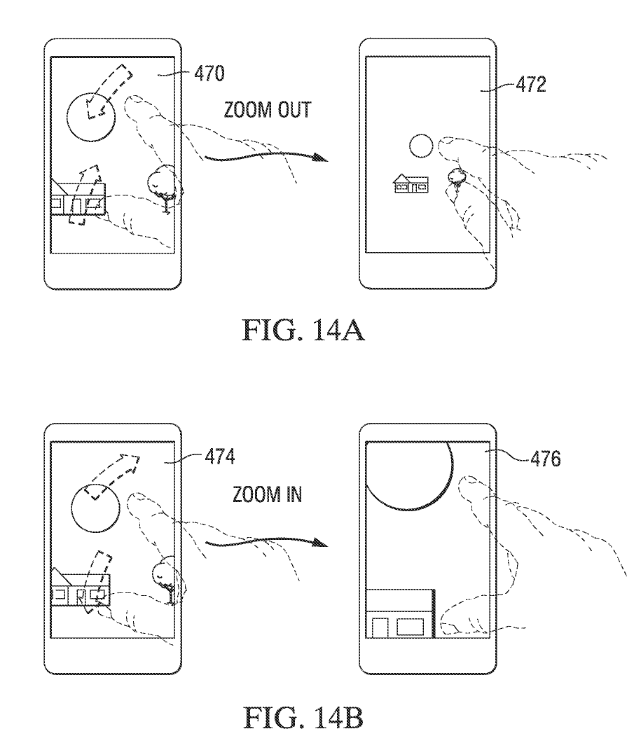

As shown in FIGS. 14A and 14B, touch based zoom allows the user to dynamically zoom out or in. Two points of contact from a user touch are mapped to pan/tilt coordinates, from which an angle measure is computed to represent the angle between the two contacting fingers. The viewing field of view (simulating zoom) is adjusted as the user pinches in or out to match the dynamically changing finger positions relative to the initial angle measure. As shown in FIG. 14A, pinching in the two contacting fingers produces a zoom out effect. That is, the object in screen 470 appears smaller in screen 472. As shown in FIG. 14B, pinching out produces a zoom in effect. That is, the object in screen 474 appears larger in screen 476.

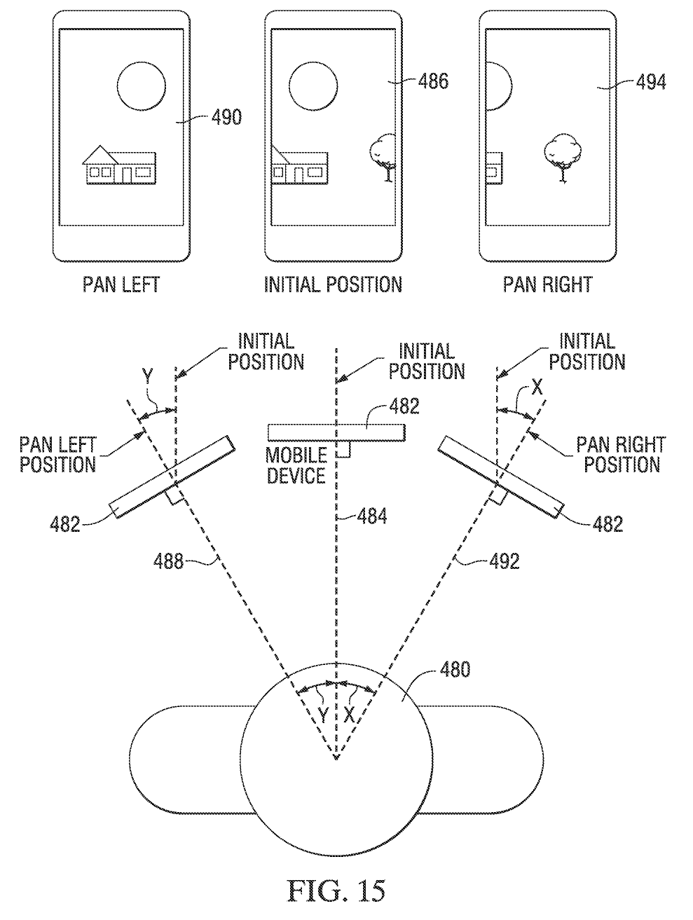

FIG. 15 illustrates an orientation-based pan that can be derived from compass data provided by a compass sensor in a mobile computing device 482, allowing the user to change the displaying pan range by turning the mobile device 482. Orientation-based pan can be accomplished through a software application executed by the mobile device processor, or as a combination of hardware and software, by matching live compass data to recorded compass data in cases where recorded compass data is available. In cases where recorded compass data is not available, an arbitrary North value can be mapped onto the recorded media. The recorded media can be, for example, any panoramic video recording. When a user 480 holds the mobile computing device 482 in an initial position along line 484, the image 486 is produced on the display of the mobile computing device 482. When a user 480 moves the mobile computing device 482 in a pan left position so as to be oriented along line 488, which is offset from the initial position by an angle Y, image 490 is produced on the device display. When a user 480 moves the mobile computing device 482 in a pan right position so as to be oriented along line 492, which is offset from the initial position by an angle X, image 494 is produced on the display of the mobile computing device 482. In effect, the display is showing a different portion of the panoramic image captured by the panoramic camera system 101 and processed by the mobile computing device 482. The portion of the image to be shown is determined by the change in compass orientation data with respect to the initial position compass data.

Under certain circumstances, it may be desirable to use an arbitrary North value even when recorded compass data is available. It may be further desirable not to have the pan angle change on a one-to-one basis with the pan angle of the mobile device 482. In some embodiments, the rendered pan angle may change at user-selectable ratio relative to the pan angle of the mobile device 482. For example, if a user chooses 4x motion controls, then rotating the mobile device 482 through 90° will allow the user to see a full 360° rotation of the video, which is convenient when the user does not have the freedom of movement to spin around completely.

In cases where touch based input is combined with an orientation input, the touch input can be added to the orientation input as an additional offset. By doing so, conflict between the two input methods is avoided effectively.

On mobile devices 482 where gyroscope data that measures changes in rotation along multiple axes over time is available and offers better performance, such data can be integrated over a time interval between a previous rendered frame and the current, to-be-rendered frame. This total change in orientation can be added to the orientation used to render the previous frame to determine the new orientation used to render the current frame. In cases where both gyroscope and compass data are available, gyroscope data can be synchronized to compass positions periodically or as a one-time initial offset.

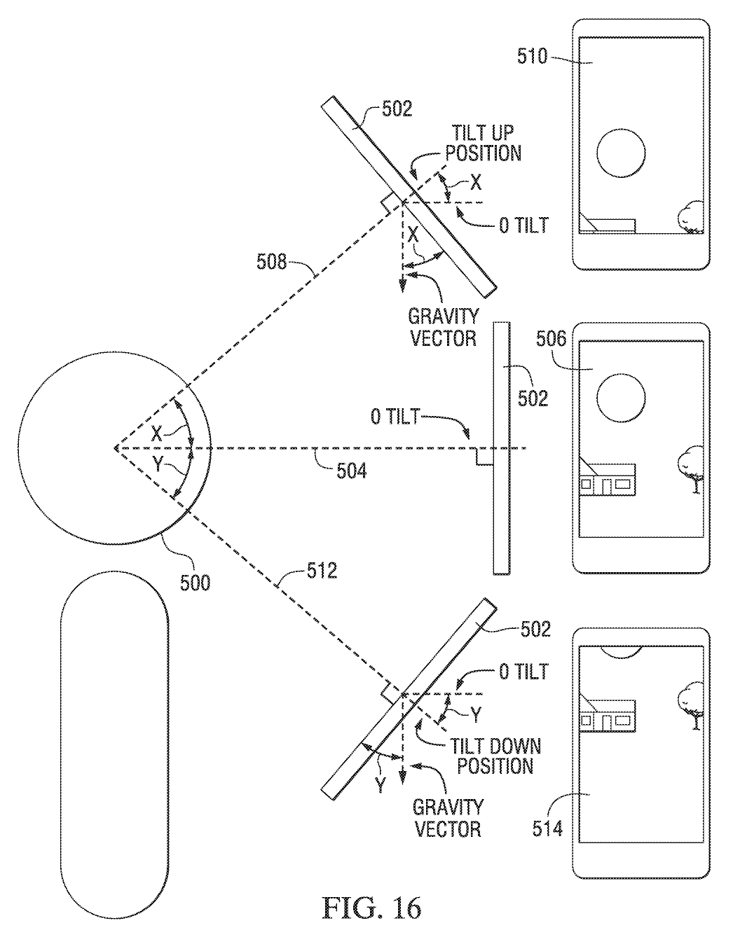

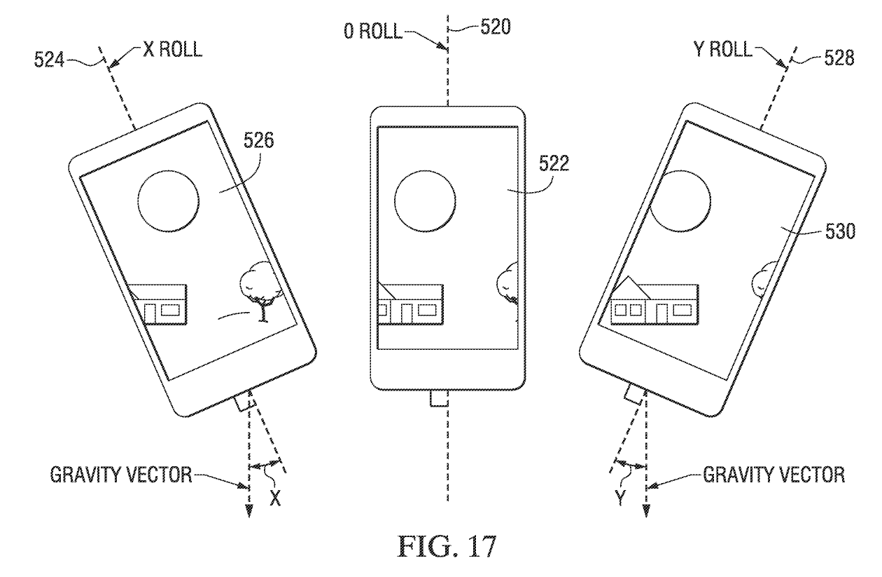

As shown in FIG. 16, an orientation-based tilt can be derived from accelerometer data, allowing a user 500 to change the displayed tilt range by tilting the mobile device 502. Orientation-based tilt can be accomplished through a software application executed by the mobile device processor, or as a combination of hardware and software, by computing the live gravity vector relative to the mobile device 502. The angle of the gravity vector in relation to the device 502 along the device's display plane will match the tilt angle of the device 502. This tilt data can be mapped against tilt data in the recorded media. In cases where recorded tilt data is not available, an arbitrary horizon value can be mapped onto the recorded media. The tilt of the device 502 may be used to either directly specify the tilt angle for rendering (i.e. holding the device 502 vertically will center the view on the horizon), or it may be used with an arbitrary offset for the convenience of the operator. This offset may be determined based on the initial orientation of the device 502 when playback begins (e.g. the angular position of the device 502 when playback is started can be centered on the horizon). When a user 500 holds the mobile computing device 502 in an initial position along line 504, image 506 is produced on the device display. When a user 500 moves the mobile computing device 502 in a tilt up position so as to be oriented along line 508, which is offset from the gravity vector by an angle X, image 510 is produced on the device display. When a user 500 moves the mobile computing device 502 in a tilt down position so as to be oriented along line 512, which is offset from the gravity by an angle Y, image 514 is produced on the device display. In effect, the display is showing a different portion of the panoramic image captured by the panoramic camera system 101 and processed by the mobile computing device 502. The portion of the image to be shown is determined by the change in vertical orientation data with respect to the initial gravity vector.

In cases where touch-based input is combined with orientation input, touch input can be added to orientation input as an additional offset.

On mobile devices where gyroscope data is available and offers better performance, such data can be integrated over the time interval between a previous rendered frame and the current, to-be-rendered frame. This total change in orientation can be added to the orientation used to render the previous frame to determine the new orientation used to render the current frame. In cases where both gyroscope and accelerometer data are available, gyroscope data can be synchronized to the gravity vector periodically or as a one-time initial offset.

As shown in FIG. 17, automatic roll correction can be computed as the angle between the device's vertical display axis and the gravity vector from the device's accelerometer. Automatic roll correction can be accomplished through a software application executed by the mobile device processor or as a combination of hardware and software. When a user holds the mobile computing device in an initial position along line 520, image 522 is produced on the device display. When a user moves the mobile computing device to an X-roll position along line 524, which is offset from the gravity vector by an angle X, image 526 is produced on the device display. When a user moves the mobile computing device in a Y-roll position along line 528, which is offset from the gravity vector by an angle Y, image 530 is produced on the device display. In effect, the display is showing a tilted portion of the panoramic image captured by the panoramic camera system 101 and processed by the mobile computing device. The portion of the image to be shown is determined by the change in vertical orientation data with respect to the initial gravity vector.

On mobile devices where gyroscope data is available and offers better performance, such data can be integrated over the time interval between a previous rendered frame and the current, to-be-rendered frame. This total change in orientation can be added to the orientation used to render the previous frame to determine the new orientation used to render the current frame. In cases where both gyroscope and accelerometer data are available, gyroscope data can be synchronized to the gravity vector periodically or as a one-time initial offset.

The touch screen is a display found on many mobile computing devices, such as the iPhone. The touch screen contains built-in touch or touch screen input sensors that are used to implement touch actions. In usage scenarios where a software platform does not contain a built-in touch or touch screen sensor, externally connected off-the-shelf sensors can be used. User input in the form of touching, dragging, pinching, etc., can be detected as touch actions by touch and touch screen sensors though the usage of off-the-shelf software frameworks.

User input in the form of touch actions can be provided to a software application by hardware abstraction frameworks on the software platform to provide the user with an interactive presentation of prerecorded media, shared media downloaded or streamed from the Internet, or media which is currently being recorded or previewed.

Many software platforms provide a facility for decoding sequences of video frames using a decompression algorithm. Common video decompression algorithms include AVC and H.264. Decompression may be implemented as a hardware feature of the mobile computing device, or through software which runs on the general CPU, or a combination thereof. Decompressed video frames are passed to a video frame buffer.

Many software platforms provide a facility for decoding sequences of audio data using a decompression algorithm. One common audio decompression algorithm is AAC. Decompression may be implemented as a hardware feature of the mobile computing device, or through software which runs on the general CPU, or a combination thereof. Decompressed audio frames are passed to an audio frame buffer and output to a speaker.

The video frame buffer is a hardware abstraction provided by any of a number of off-the-shelf software frameworks, storing one or more frames of decompressed video. These frames are retrieved by the software for various uses.

The audio buffer is a hardware abstraction that can be implemented using known off-the-shelf software frameworks, storing some length of decompressed audio. This data can be retrieved by the software for audio compression and storage (recording).

The texture map is a single frame retrieved by the software from the video buffer. This frame may be refreshed periodically from the video frame buffer in order to display a sequence of video.

Additional software functions may retrieve position, orientation, and velocity data from a media source for the current time offset into the video portion of the media source.

An interactive renderer of the mobile computing device may combine user input (touch actions), still or motion image data from the panoramic camera system 101 (via a texture map), and movement data from the media source to provide a user controlled view of prerecorded media, shared media downloaded or streamed over a network, or media currently being recorded or previewed. User input is used in real time to determine the view orientation and zoom. The texture map is applied to a spherical, cylindrical, cubic, or other geometric mesh of vertices, providing a virtual scene for the view, correlating known angle coordinates from the texture with the desired angle coordinates of each vertex. Finally, the view is adjusted using orientation data to account for changes in the pitch, yaw, and roll of the panoramic camera system 101 at the present time offset into the media.

Information from the interactive renderer can be used to produce a visible output on either an integrated display device, such as the screen on the mobile computing device, or an externally connected display device.

The speaker provides sound output from the audio buffer, synchronized to video being displayed from the interactive renderer, using either an integrated speaker device, such as the speaker on the mobile computing device, or an externally connected speaker device. In the event that multiple channels of audio data are recorded from a plurality of microphones in a known orientation, the audio field may be rotated during playback to synchronize spatially with the interactive renderer display.

The panoramic camera systems disclosed herein have many uses. For example, the camera system 101 and the mobile computing device 103 may be held or may be worn by a user to record the user's activities in a panoramic format (e.g., sporting activities and the like). Examples of some other possible applications and uses of the panoramic camera system 101 include: motion tracking; social networking; 360° mapping and touring; security and surveillance; and military applications.

For motion tracking, processing software executed by the mobile computing device can detect and track the motion of subjects of interest (people, vehicles, etc.) based on the image data received from the camera system 101 and display views following these subjects of interest.

For social networking and entertainment or sporting events, the processing software may provide multiple viewing perspectives of a single live event from multiple devices. Using geo-positioning data, software can display media from other devices within close proximity at either the current or a previous time. Individual devices can be used for n-way sharing of personal media (much like the “YouTube” or “Flickr” services). Some examples of events include concerts and sporting events where users of multiple devices can upload their respective video data (for example, images taken from the user's location in a venue), and the various users can select desired viewing positions for viewing images in the video data. Software can also be provided for using the apparatus for teleconferencing in a one-way (presentation style-one or two-way audio communication and one-way video transmission), two-way (conference room to conference room), or n-way configuration (multiple conference rooms or conferencing environments).

For 360° mapping and touring, the processing software can be written to perform 360° mapping of streets, buildings, and scenes using geospatial data and multiple perspectives supplied over time by one or more devices and users. The mobile computing device 103 with attached panoramic camera system 101 can be mounted on ground or air vehicles as well, or used in conjunction with autonomous/semi-autonomous drones. Resulting video media can be replayed as captured to provide virtual tours along street routes, building interiors, or flying tours. Resulting video media can also be replayed as individual frames, based on user requested locations, to provide arbitrary 360° tours (frame merging and interpolation techniques can be applied to ease the transition between frames in different videos, or to remove temporary fixtures, vehicles, and persons from the displayed frames).

For security and surveillance, the mobile computing device 103 with attached panoramic camera system 101 can be mounted in portable and stationary installations, serving as low profile security cameras, traffic cameras, or police vehicle cameras. One or more devices can also be used at crime scenes to gather forensic evidence in 360° fields of view.

For military applications, man-portable and vehicle mounted systems can be used for muzzle flash detection, to rapidly determine the location of hostile forces. Multiple devices can be used within a single area of operation to provide multiple perspectives of multiple targets or locations of interest. When mounted as a man-portable system, the mobile computing device 103 with attached panoramic camera system 101 can be used to provide its user with better situational awareness of his or her immediate surroundings. When mounted as a fixed installation, the apparatus can be used for remote surveillance, with the majority of the apparatus concealed or camouflaged. The apparatus can be constructed to accommodate cameras in non-visible light spectrums, such as infrared for 360 degree heat detection.

In the foregoing specification, specific embodiments have been described. However, one of ordinary skill in the art will appreciate that various modifications and changes can be made without departing from the scope of the invention as set forth in the appended claims. Accordingly, the specification and figures are to be regarded in an illustrative rather than a restrictive sense, and all such modifications are intended to be included within the scope of the present disclosure.

The benefits, advantages, solutions to problems, and any element(s) that may cause any benefit, advantage, or solution to occur or become more pronounced are not to be construed as critical, required, or essential features or elements of any or all the claims. The invention is defined solely by the appended claims including any amendments made during the pendency of this application and all equivalents of those claims as issued.

In this document, relational terms such as “first” and “second,” “top” and “bottom,” and the like may be used solely to distinguish one entity or action from another entity or action without necessarily requiring or implying any actual such relationship or order between such entities or actions. The terms “comprises,” “comprising,” “has”, “having,” “includes,” “including,” “contains,” “containing,” or any other variations thereof, are intended to cover a non-exclusive inclusion, such that a process, method, article, or apparatus that comprises, has, includes, or contains a list of elements does not include only those elements but may include other elements not expressly listed or inherent to such process, method, article, or apparatus. An element proceeded by “comprises . . . a”, “has . . . a”, “includes . . . a”, or “contains . . . a” does not, without more constraints, preclude the existence of additional identical elements in the process, method, article, or apparatus that comprises, has, includes, or contains the element. The articles “a” and “an” are defined as one or more unless explicitly stated otherwise herein. The terms “substantially,” “essentially,” “approximately,” “about,” or any other version thereof, are defined as being close to as understood by one of ordinary skill in the art, and in non-limiting embodiments, the terms may be defined to mean within 10%, within 5%, within 1%, or within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”), such as microprocessors, digital signal processors, customized processors and field programmable gate arrays (FPGAs), and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of functions are implemented as custom logic. Of course, a combination of the two approaches could be used.

Some embodiments of the disclosed method and/or apparatus may be implemented as a computer-readable storage medium having computer-readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a read only memory (ROM), a programmable read only memory (PROM), an erasable programmable read only memory (EPROM), an electrically erasable programmable read only memory (EEPROM), and a flash memory. Further, it is expected that one of ordinary skill in the art, notwithstanding possibly significant effort and many design choices motivated by, for example, available time, current technology, and economic considerations, when guided by the concepts and principles disclosed herein, will be readily capable of generating software instructions and programs to implement the disclosed methods and functions with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description as part of the original disclosure, and remain so even if cancelled from the claims during prosecution of the application, with each claim standing on its own as a separately claimed subject matter. Furthermore, subject matter not shown should not be assumed to be necessarily present, and that in some instances it may become necessary to define the claims by use of negative limitations, which are supported herein by merely not showing the subject matter disclaimed in such negative limitations.

What is claimed is:

1. A mobile device-mountable camera apparatus comprising:
a panoramic camera system that includes:
a panoramic lens assembly providing a vertical field of view in a range of greater than 180° to 360°; and
a sensor positioned in image-receiving relation to the panoramic lens assembly and operable to produce image data based on an image received through the panoramic lens assembly; and
a cable-free mounting arrangement configured to removably secure the panoramic camera system to an externally-accessible data port of a mobile computing device to facilitate transfer of the image data to processing circuitry of the mobile computing device.

2. The mobile device-mountable camera apparatus of claim 1, wherein the externally-accessible data port of the mobile computing device also functions as a battery charging port, and wherein the mounting arrangement further facilitates a supply of battery power from the mobile computing device to the panoramic camera system through the battery charging port.

3. The mobile device-mountable camera apparatus of claim 1, wherein the panoramic camera system further includes an on-board battery.

4. The mobile device-mountable camera apparatus of claim 1, wherein the vertical field of view is from 220° to 270°.

5. The mobile device-mountable camera apparatus of claim 1, wherein the panoramic lens assembly includes a single lens.

6. The mobile device-mountable camera apparatus of claim 1, wherein the panoramic lens assembly includes two or more lenses.

7. The mobile device-mountable camera apparatus of claim 1, wherein the mounting arrangement is configured to require a predetermined amount of force to insert and remove the apparatus from the externally-accessible data port of the mobile computing device.

8. The mobile device-mountable camera apparatus of claim 7, wherein the mounting arrangement is configured to require a force of from 5 to 20 pounds to remove the apparatus from the externally-accessible data port of the mobile computing device.

9. The mobile device-mountable camera apparatus of claim 1, wherein the mounting arrangement is configured to provide a clearance space between a base of the panoramic camera system and a body of the mobile computing device.

10. The mobile device-mountable camera apparatus of claim 1, wherein the mounting arrangement includes brackets configured to engage front and back surfaces of the mobile computing device when the mounting arrangement is inserted into the externally-accessible data port of the mobile computing device.

11. The mobile device-mountable camera apparatus of claim 1, wherein the mounting arrangement includes a rotatable adapter that enables the panoramic camera system to be rotated relative to the mobile computing device when the mounting arrangement is inserted into the externally-accessible data port of the mobile computing device.

12. An apparatus comprising:
a mobile computing device with processing circuitry and an externally-accessible data port;
a panoramic camera system that includes:
a panoramic lens assembly providing a vertical field of view in a range of greater than 180° to 360°; and
a sensor positioned in image-receiving relation to the panoramic lens assembly and operable to produce image data based on an image received through the panoramic lens assembly; and
a cable-free mounting arrangement configured to removably secure the panoramic camera system to the externally-accessible data port of the mobile computing device to facilitate transfer of the image data to the processing circuitry of the mobile computing device.

13. The apparatus of claim 12, wherein the externally-accessible data port of the mobile computing device also functions as a battery charging port, and wherein the mounting arrangement further facilitates a supply of battery power from the mobile computing device to the panoramic camera system through the battery charging port.

14. The apparatus of claim 12, wherein the mounting arrangement is configured to provide a clearance space between a base of the panoramic camera system and a body of the mobile computing device.

15. A processor-implemented method for displaying images on a display of a mobile computing device, the method comprising:
receiving image data from an externally-accessible data port of the mobile computing device, the image data being produced by a panoramic camera system mounted to the mobile computing device at least partially through connection to the externally-accessible data port;
processing the image data to produce a displayable video image;
displaying the video image on the display of the mobile computing device to produce a displayed image;
during display of the video image, detecting at least one of a change in orientation of the mobile computing device and a touch action on the display of the mobile computing device to produce a user input; and
modifying at least one of a viewing orientation and zoom of the displayed image in response to the user input.

16. The method of claim 15, wherein detecting at least one of a change in orientation of the mobile computing device and a touch action on the display of the mobile computing device comprises:
detecting a point of contact on the display;
mapping the point of contact to a pan/tilt coordinate; and
adjusting the pan/tilt coordinate as the point of contact is moved on the display so as to keep the pan or tilt coordinate under the point of contact.

17. The method of claim 15, wherein detecting at least one of a change in orientation of the mobile computing device and a touch action on the display of the mobile computing device comprises:
detecting two points of contact on the display;
mapping the two points of contact to two pan/tilt coordinates;
computing an angle measure representing an angle between the two points of contact based on the two pan/tilt coordinates; and
detecting changes of position of the two points of contact to produce a changed angle measure.

18. The method of claim 15, wherein detecting at least one of a change in orientation of the mobile computing device and a touch action on the display of the mobile computing device comprises:
determining an initial position of the mobile computing device based on data provided by a compass sensor of the mobile computing device to produce an initial orientation; and
detecting a change in the data provided by the compass sensor to determine a change in orientation of the mobile computing device.

19. The method of claim 15, wherein detecting at least one of a change in orientation of the mobile computing device and a touch action on the display of the mobile computing device comprises:
determining an angle of a gravity vector relative to the mobile computing device based on data provided by an accelerometer of the mobile computing device to produce an initial orientation; and
detecting a change in the data provided by the accelerometer to determine a change in the angle of the gravity vector relative to the mobile computing device, wherein the change in the angle of the gravity vector corresponds to a tilt orientation of the mobile computing device.

20. The method of claim 15, wherein detecting at least one of a change in orientation of the mobile computing device and a touch action on the display of the mobile computing device comprises:
determining an angle of a gravity vector relative to the mobile computing device in an X-Y plane based on data provided by an accelerometer of the mobile computing device to produce an initial X-Y orientation; and
detecting a change in the data provided by the accelerometer to determine a change in the angle of the gravity vector relative to the mobile computing device in the X-Y plane, wherein the change in the angle of the gravity vector in the X-Y plane corresponds to a roll orientation of the mobile computing device.
